(19) United States
(12) Patent Application Publication
(10) Pub. No.: US 2026/0315892 A1
(43) Pub. Date: Oct. 15, 2026

(54) GRADIENT PROPERTY DISTRIBUTION ACROSS A PICKLEBALL PADDLE

(71) Applicant: Sport Squad, Inc., North Bethesda, MD (US)

(72) Inventors: Richard Lee, Potomac, MD (US); Fabio Kachiwazaki, São Paulo (BR); Caleb Will Dyer, North Bethesda, GA (US); Austin Kim, Columbia, MD (US)

(21) Appl. No.: 19/641,660

(22) Filed: Apr. 8, 2026

Related U.S. Application Data
(60) Provisional application No. 63/787,224, filed on Apr. 11, 2025.

(51) Int. Cl. A63B 59/42

(52) U.S. Cl. CPC A63B 59/42

(57) ABSTRACT

A paddle with improved distribution of one or more performance characteristics (e.g., weight distribution to improve the sweet spot or twist weight) may provide enhanced stability and a more consistent feel across the paddle surface while maintaining a desired effective hitting area. Paddles with a customized distribution of weight and/or other physical properties across the paddle head may reduce discrepancies in performance between the center and edge of the paddle, which can be achieved through different sections of core, surface, frame, fillers, adhesive, film, or other features. In particular, the customized distribution may involve gradually increasing weight or adjusting other properties such as stiffness, hardness, and/or vibration damping from the center towards the edges of the paddle, contributing to a more stable feel and enabling players to maintain control over their shots even during off-center impacts.

### CROSS-REFERENCE TO RELATED APPLICATIONS

This application claims priority to U.S. Provisional Pat. App. No. 63/787,224 filed on April 11, 2025, which is hereby incorporated by reference in its entirety.

### FIELD

The present disclosure generally relates to game paddles and the like—e.g., pickleball paddles—as well as methods for making and using the same.

### BACKGROUND

Paddles for paddle sports have been used for ages. The term “paddle” typically refers to equipment where the ball striking surface does not include strings (e.g., a tennis racket would not be considered a paddle). Paddles are used to play games such as pickleball, paddleball, table tennis, padel, and the like. In particular, pickleball is a paddle sport that generally combines elements of tennis, badminton, and ping-pong. It is played on a court with similar dimensions to a badminton court and with a net dividing opposing sides. The game is played with a perforated plastic ball and solid paddles made of, for example, wood, graphite, and/or composite materials. In general, players use their paddles to hit the ball over the net, aiming to land the ball within the boundaries of the opposing side of the court. As the sport has evolved, so too has the equipment used by players, with paddle design becoming an area of particular focus.

Paddle construction typically involves a core material sandwiched between two surface layers, with a frame surrounding the perimeter. The materials and design of these components can affect various aspects of paddle performance, including power, control, and feel. Players often seek paddles that offer a balance of these characteristics to suit their individual playing styles and preferences. As such, there is ongoing interest in paddle designs that can provide enhanced performance while adhering to the rules and regulations governing equipment in competitive play.

There remains a need for pickleball paddles with improved performance characteristics such as power, control, and feel.

### SUMMARY

The present teachings may be directed to game paddles such as pickleball paddles. Specifically, the present teachings may include a paddle with improved distribution of one or more performance characteristics (e.g., weight distribution to improve the sweet spot or twist weight), including paddles that provide enhanced stability and a more consistent feel across the paddle surface while maintaining a desired effective hitting area. The present teachings may also or instead include paddles with customized distribution of weight or other physical properties across the paddle head to reduce discrepancies in performance between the center and edge of the paddle, which can be achieved through different sections of core, surface, frame, fillers, adhesive, film, or other features. In particular, the customized distribution may involve gradually increasing weight or adjusting other properties such as stiffness, hardness, and/or vibration damping from the center towards the edges of the paddle, contributing to a more stable feel and enabling players to maintain control over their shots even during off-center impacts.

In an example aspect, a paddle disclosed herein includes: a handle portion; a head portion including a first side, a second side, a top portion, and a throat portion; and a core defining at least a majority of an interior of the head portion, the core including: a first region located substantially in a center of the head portion, the first region including a first material structurally configured to provide a first weight of the first region; a second region disposed adjacent to the first region at least along sides of the first region in a direction toward each of the first side and the second side of the head portion, the second region including a second material structurally configured to provide a second weight of the second region, the second weight greater than the first weight; and a third region disposed adjacent to the second region at least along sides of the second region in the direction toward each of the first side and the second side of the head portion, the third region including a third material structurally configured to provide a third weight of the third region, the third weight greater than the second weight, and wherein weight distribution provided by the first region, the second region, and the third region increases resistance of the paddle to twisting when contacting a ball along one or both of the first side and the second side of the head portion relative to paddles lacking the weight distribution.

Implementations of this example aspect, or any other example aspect described in this summary section or otherwise herein, may include one or more of the following features. The first material, the second material, and the third material may be different materials. The first material, the second material, and the third material may have different material properties. At least two of the first material, the second material, and the third material may be the same materials. One or more of the first region, the second region, and the third region may include a gradient of a material property across at least a portion thereof. One or more of density, size, material distribution, shape, and physical structure may provide different weights for at least two regions using the same materials. At least two of the first region, the second region, and the third region may have differences in one or more of the following: stiffness, hardness, and vibration damping. The first region may include a first substantially open cell structure.One or more of the second region and the third region may include a substantially open cell structure. The first substantially open cell structure of the first region may be different than the substantially open cell structure of one or more of the second region and the third region. The first substantially open cell structure may include a difference in one or more of the following relative to the substantially open cell structure of one or more of the second region and the third region: cell shape, cell size, and cell wall thickness. The paddle may include one or more additional regions disposed outside of the third region, and the one or more additional regions may have a weight that is different from the first weight, the second weight, and the third weight. One or both of the second region and the third region may completely surround the first region. The first region may have a predetermined shape, the second region may envelop a perimeter of the first region, and the third region may envelop a perimeter of the second region. The predetermined shape may be substantially polygonal. The second region may completely surround the first region. The second weight may be greater along sides of the second region than it is toward one or both of the top portion and the throat portion. The third region may completely surround the second region. The third weight may be greater along sides of the third region than it is toward one or both of the top portion and the throat portion. The first region may contact the second region and the second region may contact the third region. The paddle may include a frame. The frame may be substantially disposed along, or adjacent to, a perimeter of the head portion of the paddle. The frame may substantially surround the third region. The frame may be structurally configured to provide a fourth weight along each of the first side and the second side of the head portion, and the fourth weight may be greater than the first weight. The fourth weight may be greater than each of the first weight, the second weight, and the third weight. The fourth weight may be provided at least in part by a filler material within the frame.

In an example aspect, a paddle disclosed herein includes: a handle portion; and a head portion including a first side, a second side, a top portion, and a throat portion, the head portion including: a first region located substantially in a center of the head portion, the first region including a first material structurally configured to provide a first weight of the first region; a second region disposed adjacent to the first region at least along sides of the first region in a direction toward each of the first side and the second side of the head portion, the second region including a second material structurally configured to provide a second weight of the second region, the second weight greater than the first weight; and a third region disposed adjacent to the second region at least along sides of the second region in the direction toward each of the first side and the second side of the head portion, the third region including a third material structurally configured to provide a third weight of the third region, the third weight greater than the second weight, wherein weight distribution provided by the first region, the second region, and the third region increases resistance of the paddle to twisting when contacting a ball along one or both of the first side and the second side of the head portion relative to paddles lacking the weight distribution.

Implementations of this example aspect, or any other example aspect described in this summary section or otherwise herein, may include one or more of the following features. The first region, the second region, and the third region may be formed in a core of the paddle. The first region, the second region, and the third region may be formed in one or more of a front surface and a back surface of the paddle.

In an example aspect, a method of manufacturing a pickleball paddle disclosed herein includes: forming a first region of a core, the first region including a first material structurally configured to provide a first weight of the first region; forming a second region of the core, the second region including a second material structurally configured to provide a second weight of the second region, the second weight greater than the first weight; forming a third region of the core, the third region including a third material structurally configured to provide a third weight of the third region, the third weight greater than the second weight; forming the core with the first region located substantially in a center of a head portion, the second region disposed adjacent to the first region at least along sides of the first region in a direction toward each of the first side and the second side of the head portion, and the third region disposed adjacent to the second region at least along sides of the second region in the direction toward each of the first side and the second side of the head portion; applying a front surface and a back surface to the core, the front surface opposing the back surface; and implementing a weight distribution system structurally configured to provide an increasing weight distribution from a center region of the pickleball paddle towards an outer perimeter of the pickleball paddle, wherein weight varying properties of the core comprise at least a part of the weight distribution system.

Implementations of this example aspect, or any other example aspect described in this summary section or otherwise herein, may include one or more of the following features. One or more of the front surface and the back surface may include a plurality of regions having differing weights to provide at least a part of the weight distribution system. The method may include surrounding the core with a frame that contributes to the weight distribution system. The method may further include applying an edge guard that contributes to the weight distribution system.

In an example aspect, a pickleball paddle disclosed herein includes: a front surface; a back surface opposing the front surface; a core disposed between the front surface and the back surface; and a weight distribution system structurally configured to provide an increasing weight distribution from a center region of the paddle towards an outer perimeter of the paddle, wherein the weight distribution system comprises at least one of (i) the core having weight varying properties and (ii) one or more of the front surface and the back surface having weight varying properties.

Implementations of this example aspect, or any other example aspect described in this summary section or otherwise herein, may include one or more of the following features. 35. The increasing weight distribution may extend laterally across the paddle from the center region to the outer perimeter along sides of the paddle. The core may include weight varying properties including a plurality of sections of core material, each section having different properties. The different properties may include at least one of: density, stiffness, hardness, and vibration damping characteristics. The plurality of sections of core material may substantially surround the center region of the paddle. One or more of the front surface and the back surface may have weight varying properties including a plurality of sections of surface material, each section having different properties. The different properties may include at least one of: density, stiffness, hardness, and vibration damping characteristics. The plurality of sections of surface material may substantially surround the center region of the paddle. The paddle may include a frame surrounding the core, and the frame may contribute to the weight distribution system.

In an example aspect, a pickleball paddle disclosed herein includes: a handle portion; a head portion including a first side, a second side, a top portion, and a throat portion; a core defining an interior of the head portion; and a front surface and a back surface sandwiching the core, at least one of the front surface and the back surface including: a first region located substantially in a center of the head portion, the first region including a first material structurally configured to provide a first weight of the first region; a second region disposed adjacent to the first region at least along sides of the first region in a direction toward each of the first side and the second side of the head portion, the second region including a second material structurally configured to provide a second weight of the second region, the second weight greater than the first weight; and a third region disposed adjacent to the second region at least along sides of the second region in the direction toward each of the first side and the second side of the head portion, the third region including a third material structurally configured to provide a third weight of the third region, the third weight greater than the second weight, wherein weight distribution provided by the first region, the second region, and the third region increases resistance of the paddle to twisting when contacting a ball along one or both of the first side and the second side of the head portion relative to paddles lacking the weight distribution.

Implementations of this example aspect, or any other example aspect described in this summary section or otherwise herein, may include one or more of the following features. Each of the front surface and the back surface may include a plurality of layers of material. One or more of the plurality of layers of material may include the first material, the second material, and the third material.

In an example aspect, a pickleball paddle disclosed herein includes: a handle portion; and a head portion including a first side, a second side, a top portion, and a throat portion, the head portion including: a first region located substantially in a center of the head portion, the first region including a first material property structurally configured to provide a first performance property of the first region; a second region disposed adjacent to the first region at least along sides of the first region in a direction toward each of the first side and the second side of the head portion, the second region including a second material property structurally configured to provide a second performance property of the second region, the second performance property different than the first performance property; and a third region disposed adjacent to the second region at least along sides of the second region in the direction toward each of the first side and the second side of the head portion, the third region including a third material property structurally configured to provide a third performance property of the third region, the third performance property different than the second performance property.

Implementations of this example aspect, or any other example aspect described in this summary section or otherwise herein, may include one or more of the following features. One or more of the first performance property, the second performance property, and the third performance property may include at least one of: a stiffness, a hardness, a vibration damping property, and a weight. One or more of the first performance property, the second performance property, and the third performance property may provide a substantial consistency of performance when contacting a ball in each of the first region, the second region, and the third region.

In an example aspect, a pickleball paddle disclosed herein includes: a front surface; a back surface opposing the front surface; a core disposed between the front surface and the back surface; and a performance property distribution system structurally configured to provide a distribution of different material properties from a center region of the paddle towards an outer perimeter of the paddle, wherein the performance property distribution system comprises at least one of (i) the core having varying material properties and (ii) one or more of the front surface and the back surface having varying material properties.

Implementations of this example aspect, or any other example aspect described in this summary section or otherwise herein, may include one or more of the following features. The distribution of different material properties may include a distribution of at least one of: a stiffness, a hardness, a vibration damping property, and a weight. The performance property distribution system may provide a substantial consistency of performance when contacting a ball in regions from the center region to the outer perimeter.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 shows a pickleball paddle, according to a representative example.

FIG. 2 shows a cross-sectional view along the line 2-2 of the pickleball paddle of FIG. 1, according to a representative example.

FIG. 3 shows a core of a pickleball paddle, according to a representative example.

FIG. 4 shows a core of a pickleball paddle, according to a representative example.

FIG. 5 shows a core of a pickleball paddle, according to a representative example.

FIG. 6A shows an end view of the core of FIG. 5 before pressure is applied, according to a representative example.

FIG. 6B shows an end view of the core of FIG. 5 after pressure is applied, according to a representative example.

FIG. 7 shows a core of a pickleball paddle, according to a representative example.

FIG. 8A shows an enlarged partial view of a core of a pickleball paddle, according to a representative example.

FIG. 8B shows an enlarged partial view of a core of a pickleball paddle, according to a representative example.

FIG. 9 is a flow chart of a method of manufacturing a pickleball paddle, in accordance with a representative example.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, and methods disclosed herein relate to paddles such as pickleball paddles. However, it will be understood that, while this disclosure may emphasize the present teachings in the context of pickleball, the present teachings may be adapted and practiced in other sports and activities, including without limitation one or more of: tennis, badminton, squash, racquetball, table tennis (ping pong), padel, and the like. Thus, it shall be understood that, unless expressly stated to the contrary, or otherwise clear from the context, the present teachings are intended to include comparable equipment in other sports/activities in addition to, or instead of, pickleball.

The present teachings may relate to paddles (e.g., pickleball paddles) with customized distribution of weight and/or other performance characteristics across the paddle head. More specifically, the pickleball paddles and methods disclosed herein may relate to paddles with gradually increasing or decreasing weight and/or other differing physical properties from the center towards the edges of the paddle head, which may be achieved through different sections of core, surface, frame, fillers, adhesive, film, or other features. The present teachings may also or instead include paddles with multiple regions having different material properties such as stiffness, hardness, vibration damping characteristics, and the like. These customized distributions may contribute to enhanced stability, improved resistance to twisting during off-center hits, and/or a more consistent feel across the paddle surface while maintaining a large effective hitting area. In some implementations, the weight and/or property distribution may be achieved by providing any of: variations in material, densities or other properties of the same material, or structural configurations in the core or playing surfaces; multiple layers in the core or surfaces, where the layers have different properties; the frame, the edge guard, a filler, an adhesive layer, a film layer, or similar structurally configured to contribute to a property distribution; and the like. The present teachings may further include methods of manufacturing such paddles, which may involve providing a core with varying properties, applying surfaces with customized characteristics, and/or implementing weight and/or property distribution systems through various structural configurations.

Thus, in aspects of the present teachings, a paddle may include multiple regions within the head portion, where the regions may include differences in any of: material, weight, density, size, material distribution, shape, physical structure, stiffness, hardness, vibration damping, and the like. The different regions may be formed in any one or more of the core, the front surface, and the back surface. In an aspect, the multiple regions may be provided by at least one of (i) the core having varying material properties and/or (ii) one or more of the front surface and the back surface having varying material properties. In an aspect, the frame may be considered to be a region of the paddle head (or the frame, or a portion thereof, may be at least a part of a region of the paddle head), and may provide a different performance property than another region of the paddle head. A filler within, or between, the frame or the core may also or instead be configured to provide one of the regions, or a portion thereof. In an aspect, rather than being discretized, the regions may be part of a continuous, or substantially continuous, gradient distribution of a material property across at least a portion of the paddle head; e.g., a gradual increase in material density of a core from the center toward the edges of the head may effectively establish or define the multiple different regions. In general, such property distributions are designed to provide a substantial consistency of performance when contacting a ball in each of the regions (e.g., by increasing resistance of the paddle to twisting relative to paddles lacking a property distribution).

It will be understood that the term “paddle” or “pickleball paddle” as used herein may generally refer to a hand-held implement used to strike a ball in the sport of pickleball or similar, typically comprising a handle portion and a head portion with one or more playing surfaces for contacting the ball. It will further be understood that, as stated above, where the term “pickleball paddle” is used, other paddles are also or instead possible unless expressly stated to the contrary or otherwise clear from the context.

It will be understood that the term “head portion” as used herein may generally refer to the wider, upper section of a paddle that includes the main playing surface(s) used for striking a ball during gameplay. And it will be understood that the term “handle portion” as used herein shall generally refer to the narrower, lower section of a paddle that is gripped by a player during gameplay, typically extending from the head portion and providing a means for controlling and maneuvering the paddle.

It will be understood that the term “core” or “core portion” as used herein may generally refer to a structural component of the paddle that forms part of the striking surface and/or is part of the internal structure of the paddle. A paddle may include multiple core portions, such as a first core portion, a second core portion, and the like. The core or core portions may be at least partially bounded by a frame. The core or core portions may include materials such as polypropylene, foam, aluminum, Nomex, Kevlar, and/or any other synthetic or natural material. The core may include a solid core and/or one including a honeycomb structure and/or an open-cell structure and/or lattice structure.

It will be understood that the term “frame” as used herein may generally refer to a structural component of a paddle that provides a desired shape and/or rigidity for the paddle. The frame may surround at least a portion of the perimeter of a paddle, and may be present in one or both of a head portion or handle portion of a paddle.

It will be understood that the term “filler” as used herein may generally refer to a material used to occupy space within the paddle structure, such as within the frame and/or between other components, which may provide additional structural support, weight distribution, or other functional properties to the paddle.

It will be understood that the term “edge guard” as used herein may generally refer to a protective component applied to the outer perimeter of a pickleball paddle, typically covering at least a portion of the frame to provide durability and impact resistance.

It will be understood that the term “playing surface” as used herein may generally refer to the exterior surface of the paddle that is structurally configured to contact the ball during play. The playing surface may be defined by one or more of the core portions or may be a separate component coupled to the core portions.

It will be understood that the term “weight distribution system” or similar as used herein may generally refer to a configuration of materials, structures, and/or properties within a pickleball paddle designed to provide a specific distribution of weight over at least a portion of the paddle.

It will be understood that the term “performance property distribution system” or similar as used herein may generally refer to a configuration of materials, structures, and/or properties within a pickleball paddle designed to provide a distribution of a material property (such as stiffness, hardness, vibration damping, or weight) over at least a portion of the paddle.

It will be understood that the term “performance property” or similar as used herein may generally refer to a characteristic of the pickleball paddle that affects its performance during play, which may, for example, include properties such as weight, stiffness, hardness, vibration damping capabilities, and the like.

It will be understood that the term “discrete regions,” “discretized regions,” or similar as used herein may generally refer to distinct, identifiable sections or portions of a paddle component (e.g., a core, surface, or frame), generally characterized by having a discernible boundary where one material property ends and another begins. Such regions may include substantially uniform material properties within the boundaries of the specific region, which differ from the properties of an adjacent region.

It will be understood that the term “continuous gradient,” “substantially continuous gradient,” or similar as used herein may generally refer to a distribution of a material property (such as density, stiffness, or weight) that varies progressively as a function of position across at least a portion of the paddle. In a continuous gradient, the transition between different property values occurs without abrupt or step-like changes, and such a distribution may effectively define, delineate, or manifest as multiple functional regions within the paddle structure.

It will further be understood that, in certain implementations, the paddle may incorporate a hybrid distribution system wherein discrete regions and continuous gradients coexist or overlap. For example, a boundary between a first region and a second region may be established when a specific material property crosses a predetermined threshold, such as a target density, weight, stiffness value, or vibration damping coefficient. In such a scenario, while one or more of the regions may themselves include an internal gradient distribution of properties, the functional transition between the regions may be defined by the property surpassing the predetermined threshold. Alternatively, a boundary of a discrete region may be defined by a pronounced change in a material property—such as a non-linear inflection point in a property curve or a step-change in a structural characteristic (e.g., a shift in cell wall thickness or a transition from a substantially open-cell to a substantially closed-cell structure)—thereby creating a distinct functional demarcation between adjacent portions of the paddle head. Such implementations may allow the paddle to maintain a substantial consistency of performance across the striking surface while providing targeted reinforcement or weight at specific lateral or vertical positions.

It will be understood that any of the devices, systems, apparatus, methods, kits, and so forth as described herein may include one or more features as described in Int’l Pat. App. No. PCT/US2024/042535 filed on August 15, 2024 (and published as WO2025/049122), the entire contents of which is hereby incorporated by reference.

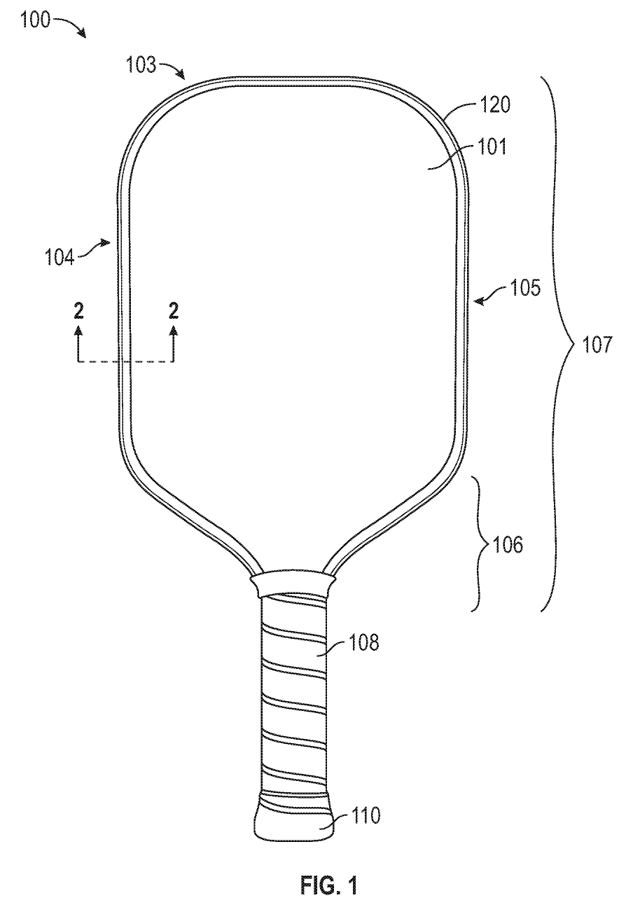

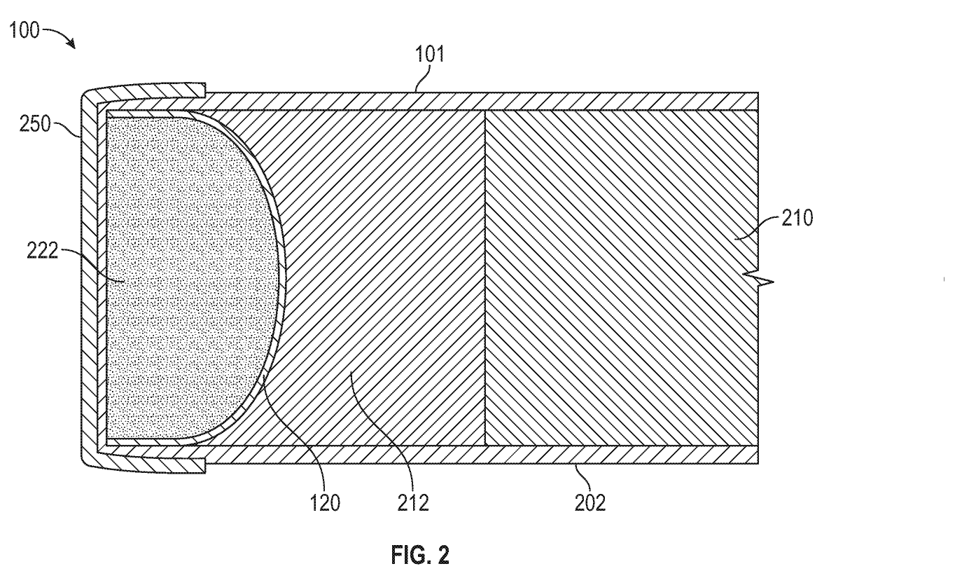

FIG. 1 illustrates a paddle 100 (e.g., a pickleball paddle used for playing the sport of pickleball), and FIG. 2 illustrates a partial cross-sectional view of the paddle 100 taken along the line 2-2 of FIG. 1, according to a representative example. The paddle 100 may include a first surface 101 and a second surface 202 (see FIG. 2), where each can generally serve as a playing surface (e.g., a front surface or a back surface). The paddle 100 may define several regions including a top 103, a first side 104, a second side 105, a head portion 107, a throat 106, a handle portion 108, and an end cap 110. These regions may define the overall shape and structure of the paddle 100. A frame 120 may extend around at least a portion of the perimeter of the paddle 100—e.g., the head portion—and may provide structural support. The paddle 100 may further include a core 210, as shown in FIG. 2.

The head portion 107 of the paddle 100 may include the first surface 101 and the second surface 202 of the paddle 100 that may serve as playing surfaces for striking a ball during gameplay. The first surface 101 and the second surface 202 may be positioned on opposite sides of the paddle 100, providing two distinct striking surfaces for the player. In certain aspects, one or both of the first surface 101 and the second surface 202 may be part of the core 210 of the paddle 100 (e.g., extensions of the core 210 of the paddle 100), or one or both of the first surface 101 and the second surface 202 may be discrete elements that are coupled to the core 210 or another portion of the paddle 100. The first surface 101 and the second surface 202 of the paddle 100 may extend across a majority of the head portion of the paddle 100, covering a majority, or all, of the area from the top 103 to the throat 106, and between the first side 104 and the second side 105. In some instances, the first surface 101 and the second surface 202 of the paddle 100 may extend onto the handle portion of the paddle 100 (and may be covered with, e.g., a wrap or other gripping component).

The frame 120 may extend around the perimeter of the paddle 100 (e.g., where the frame 120 defines the outer boundaries of the paddle 100)—or may be in proximity to the perimeter of the paddle 100—where the frame 120 can provide structural support. In certain aspects, the frame 120 may be disposed around the entire paddle 100, encompassing both the head portion and the handle portion. The frame 120 may follow the contours of the paddle 100, including the top 103, the first side 104, the second side 105, and the throat 106. The frame 120 may be disposed within an interior of the paddle 100, along an exterior of the paddle 100 (e.g., forming an external perimeter thereof), or the frame 120 may be disposed partially internal to and/or partially external along the paddle 100.

The frame 120 may serve multiple functions in the paddle 100 structure. For example, the frame 120 may provide rigidity and stability to the overall paddle 100 shape, helping to maintain the integrity of the playing surfaces during gameplay. The frame 120 may also or instead contribute to the weight distribution and balance of the paddle 100, which may affect the paddle’s maneuverability and performance characteristics. The frame 120 may be constructed as a single continuous piece or may comprise multiple sections. The frame 120 may have various cross-sectional profiles, such as having different shapes and/or sizes, and/or the frame 120 may be hollow (e.g., where the frame 120 is partially or wholly filled with a filler), solid, or a combination thereof. In certain aspects, the frame 120 may be constructed from materials selected for their strength, durability, and weight characteristics. These materials may include, but are not limited to, various metals, composites, and/or polymers. In an aspect, the frame 120 includes a carbon fiber material (or similar) fillable with a foam filler (or other filler material). The choice of material for the frame 120 may influence the overall weight, stiffness, and feel of the paddle 100 during play. In certain aspects, the frame 120 may include features for attaching additional components, such as a grip on the handle portion or an edge guard around the perimeter of the paddle 100. These features may include grooves, channels, and/or engagement points integrated into the structure of the frame 120.

The design of the paddle 100 may allow for a customized distribution of weight and/or other physical properties (such as, e.g., density, stiffness, hardness, and vibration damping characteristics) across different regions of the head portion 107. This customization may enhance the paddle’s resistance to twisting during off-center hits and provide a more consistent feel across the striking surface. The paddle 100 may also or instead incorporate various materials and structural configurations in its core and/or surfaces to achieve desired performance characteristics.

FIG. 2 shows a paddle structure including a first surface 101 and a second surface 202 with a core 210 positioned therebetween. The first surface 101 and the second surface 202 may form the playing surfaces of the paddle. In an aspect, a first filler 212 may be disposed between the first surface 101 and a second surface 202, as well as between the core 210 and a frame 120. The frame 120 may extend along an edge portion of the perimeter of the paddle 100, e.g., substantially disposed along, or adjacent to, a perimeter of the head portion 107. A second filler 222 may be disposed within the frame 120. An edge guard 250 may extend around at least a portion of the edge of the paddle and/or an exterior portion of the frame 120. The edge guard 250 may provide protection for the frame 120 and/or other components of the paddle during gameplay or transport. The edge guard 250 may be constructed from a durable material capable of withstanding impacts and wear.

The core 210 may be any as described herein or otherwise known in the art. The core 210 may be formed from a first material. In certain aspects, the first material may include at least one of: polypropylene, metal, Nomex, Kevlar, a fibrous material (e.g., carbon fiber), foam, a polymer, wood, a corrugated material, polystyrene, phenolic resin, and the like. In certain aspects, the core 210 may at least partially include a honeycomb structure and/or an open-cell structure. These structures may provide a balance of strength and lightweight properties for the paddle 100. The honeycomb or open-cell structure may allow for efficient energy transfer when striking a ball, potentially enhancing the paddle’s performance. In general, the selection of the material(s) for the core 210, and its configuration, may influence the overall weight, stiffness, and performance characteristics of the paddle 100.

The core 210 may be designed to be replaceable in certain paddle configurations. This feature may allow for customization of the paddle’s performance characteristics without replacing the entire paddle structure. For example, the core 210 may be replaced in a manner similar to changing strings in a tennis racket, where the frame 120 remains the same, but the interior component is changed. The core 210 may, in some configurations, serve as the striking surface of the paddle 100 without a separate surface layer. In such configurations, the first surface 101 and the second surface 202 may be formed directly from the material of the core 210. This construction may simplify the manufacturing process of the paddle 100.

The first filler 212 or the second filler 222 may provide specific weight or performance characteristics to the paddle 100. The second filler 222 may contribute to a weight along the first side 104 and the second side 105 of the head portion 107. In some implementations, this weight may be greater than weights provided by other regions of the paddle 100.

Any one or more of the core 210, the first surface 101, and the second surface 202 may include a plurality of layers of material. These layers may incorporate different materials with varying properties to achieve desired performance characteristics across different regions of the paddle 100. For example, the layers may include materials that contribute to first, second, and third regions with distinct properties, formed in the front surface and/or back surface of the paddle 100. In certain implementations, a gradient distribution of properties may be formed in the interface between the core 210 and the surfaces 101, 202. This gradient distribution may be achieved through the use of adhesives or other interstitial materials with varying properties. The combination of the core 210, the first surface 101, the second surface 202, the frame 120, and the edge guard 250 may allow for customization of weight distribution and other physical properties across different regions of the paddle 100, potentially enhancing performance and feel during play.

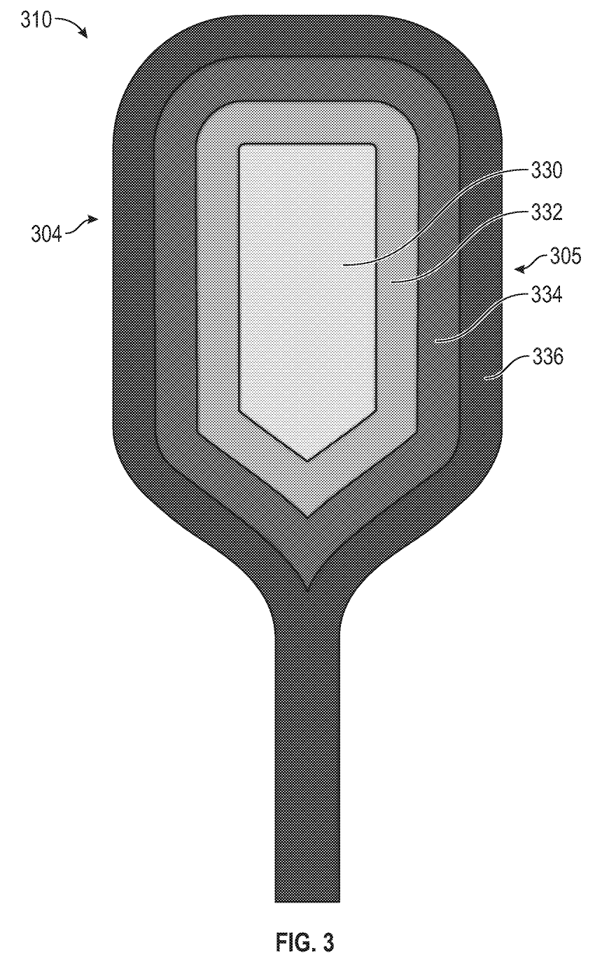

FIG. 3 shows a core 310 of a pickleball paddle, according to a representative example. By way of example, the core 310 may be used as the core structure of the paddle described above with reference to FIG. 1. Turning back to FIG. 3, the core 310 may define at least a majority of an interior of the head portion, and may in some aspects define at least a portion of an interior of the handle. The core 310 may include multiple regions (e.g., a first region 330, a second region 332, a third region 334, and one or more additional regions 336), where such regions may be arranged in a generally concentric pattern to provide a performance property distribution configuration. The property distribution configuration of the core 310 may provide a smooth transition in feel for the player across the paddle surface, contributing to a more consistent performance when contacting a ball in each of the first region 330, the second region 332, and the third region 334. While the example of FIG. 3 is discussed with reference to the core 310, it will be understood that a similar configuration may also or instead be present in one or more surfaces, and/or other elements of the paddle (e.g., the frame, filler materials, etc.), to achieve performance enhancements, alter feel, or the like.

The first region 330 is shown being located substantially in a center of the head portion of the core 310. The first region 330 includes a first material which may be structurally configured to provide a first property—e.g., a first weight—of the first region 330. In certain aspects, the first region 330 may have a predetermined shape, such as a substantially polygonal shape, a substantially circular shape (or other rounded shape), or the like.

The second region 332 may be disposed adjacent to the first region 330 at least along sides of the first region 330 in a direction toward each of the first side 304 and the second side 305 of the head portion. The second region 332 includes a second material which may be structurally configured to provide a second property—e.g., a second weight—of the second region 332. In an aspect, the properties of each of the first region 330, second region 332, and third region 334 may change (e.g., increase or decrease) from the center of the head portion to the sides of the head portion; for example, the second weight may be greater than the first weight. In some implementations, the second region 332 may completely surround the first region 330 or may envelop a perimeter of the first region 330. In an aspect, some or all of the perimeter of the first region 330 may contact the second region 332. The second region 332 may be discontinuous; e.g., the second region 332 may include portions disposed on either side of the first region 330 and those portions may or may not be connected to one another. The second region 332 may have a substantially constant thickness, as measured from the first region 330 toward the perimeter of the paddle, or the second region 332 may have a variable thickness or otherwise be irregularly shaped.

A third region 334 may be disposed adjacent to the second region 332 at least along sides of the second region 332 in the direction toward each of the first side 304 and the second side 305 of the head portion. The third region 334 includes a third material structurally configured to provide a third property—e.g., a third weight—of the third region 334, where the third weight may be greater than the second weight. The third region 334 may completely surround the second region 332 or envelop a perimeter of the second region 332. In an aspect, some or all of the perimeter of the second region 332 may contact the third region 334. The third region 334 may or may not be discontinuous, or have an irregular shape.

One or more additional regions 336 may be disposed outside of the third region 334. An additional region 336 may have a weight, or other property, that is different from one or more of the first weight, the second weight, and the third weight. The additional region 336 may also or instead include a frame, an edge guard, a film, an adhesive, or the like.

In the example of weight distribution, the weight distribution provided by the first region 330, the second region 332, and the third region 334 may increase resistance of the paddle to twisting when contacting a ball along one or both of the first side and the second side of the head portion relative to paddles lacking the weight distribution. This increasing (or decreasing) weight distribution may extend laterally across the paddle from the center region to the outer perimeter along sides of the paddle. In an aspect, the second weight may be greater along sides of the second region 332 than it is toward one or both of the top portion and the throat portion. Similarly, the third weight may be greater along sides of the third region 334 than it is toward one or both of the top portion and the throat portion. Also or instead, the increasing (or decreasing) weight distribution may extend vertically toward one or more of the top of the paddle and the bottom of the paddle from the center region. In an example aspect, the densities of the first region 330, the second region 332, and the third region 334 may be in the range of about 5 kg/m³ to about 150 kg/m³. In an example aspect, the densities of the first region 330, the second region 332, and the third region 334 may be in the range of about 20 kg/m³ to 90 kg/m³. In an example aspect, the percent difference in density or weight between the first region 330 and the third region 334 may be about 350%.

In certain aspects, the first material, the second material, and the third material may be different materials with different material properties. Alternatively, at least two of the first material, the second material, and the third material may be the same materials—e.g., but where the material is structurally configured differently in these regions to provide different properties for a paddle. For example, the different properties for regions including the same material may be provided by variations in one or more of density, size, material distribution, shape, physical structure, and the like. One or more of the first region 330, the second region 332, and the third region 334 may include a gradient of a material property across at least a portion thereof. The regions may have differences in one or more of stiffness, hardness, vibration damping characteristics, and the like. In an example aspect, the first region 330 may include a relatively soft ethylene vinyl acetate (EVA) with a density of about 30 kg/m³; the second region 332 may include polyurethane (PU) with a density of about 50 kg/m³; and the third region 334 may include expanded polypropylene (EPP) with a density of about 80 kg/m³. In an another example aspect, the first region 330 may include PU with a density of about 30 kg/m³; the second region 332 may include EVA with a density of about 50 kg/m³; and the third region 334 may include EPP with a density of about 80 kg/m³. In another aspect, the second region 332 may have a lower density than each of the first region 330 and third region 334.

In some implementations, one or more of the first region 330, the second region 332, and the third region 334 may include a substantially open cell structure. The substantially open cell structure may be different between the regions, e.g., one region may include a difference in one or more of cell shape, cell size, and cell wall thickness relative to another region. In some implementations, one or more of the first region 330, the second region 332, and the third region 334 may include a substantially open cell structure, while another one or more of the first region 330, the second region 332, and the third region 334 may include a substantially closed cell structure. Also or instead, one or more of the first region 330, the second region 332, and the third region 334 may include a substantially open cell structure, where each of these regions includes cells at least partially filled with one or more materials, where the density, volume, weight, distribution, or specific material composition of the filler material may vary across the regions to provide a targeted performance characteristic, such as a localized weight, stiffness, or vibration damping property. For example, the cells of the third region 334 may include a higher volume or a higher-density filler than the cells of the first region 330 to contribute to an increasing weight distribution toward the outer perimeter of the paddle. Additionally or alternatively, the filler material may be disposed within the cells in a gradient pattern, such that the amount of filler within an individual region progressively increases or decreases in a radial or lateral direction.

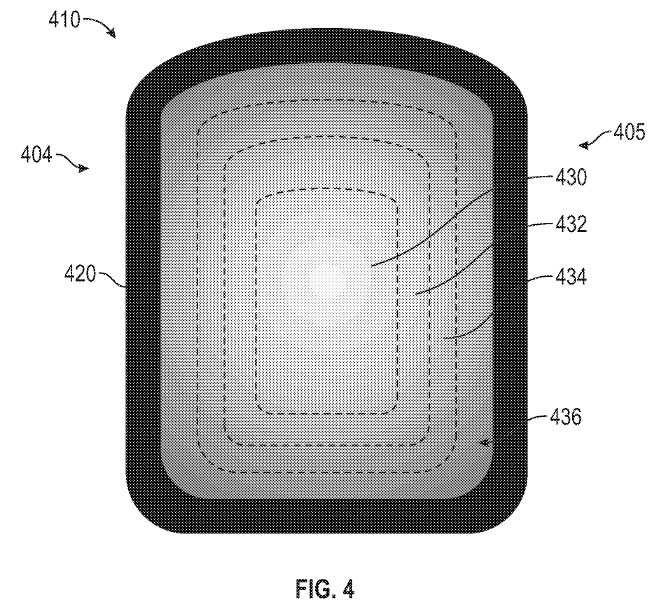

FIG. 4 shows a core 410 of a pickleball paddle, according to a representative example. By way of example, the core 410 may be used as the core structure of the paddle described above with reference to FIG. 1. Turning back to FIG. 4, the core 410 may include multiple regions with different property distributions, specifically, a first region 430, a second region 432, a third region 434, and one or more additional regions 436. A frame 420 may substantially surround the perimeter of the core 410. The regions may be arranged in a generally concentric pattern, with each subsequent region extending outward from the center. Each region may have different material properties, densities, and/or structural configurations to achieve a desired property distribution across the paddle head. In certain aspects, the property distribution may increase (e.g., an increasing weight) from the first region 430 outwardly to the additional regions 436, which may, for example, contribute to increased resistance to twisting when contacting a ball. Additionally or alternatively, one or more of the front surface and the back surface used with the core 410 may have varying properties, such as a plurality of sections of surface material, where each section has different properties.

The regions of the core 410 may include features similar to those described with reference to the core 310 of FIG. 3. In an aspect, any of the regions may include a property distribution within the region, for example, a weight may be increased in a substantially radial manner, or in a gradient pattern following a profile that is other than radial, from the center of the head portion toward the sides (e.g., as indicated by the gradient shading). In this manner, one or more of the regions may be considered to include a plurality of smaller distinct regions; thus, the separation of the regions with dashed lines as shown is used for convenience and does not indicate that any given region is consistent throughout in terms of material properties or structure.

Additionally or instead, the dashed lines may delineate a transition where a material property crosses a predetermined functional threshold or exhibits a more pronounced change. For example, a dashed line may represent a boundary where a performance property, such as density, stiffness, or vibration damping, reaches a value that significantly alters the local response of the paddle to a ball impact. In another aspect, the dashed lines may identify structural inflection points within a continuous gradient, such as a localized shift in the rate of change of a property, a change in cell wall thickness, or a transition in the concentration or type of a filler material within the core. By defining these regions via thresholds or pronounced changes, the paddle may be tuned to provide specific performance characteristics across different zones of the striking surface while maintaining a smooth, integrated feel.

The first region 430 may be located substantially in the center of the head portion. The second region 432 may substantially surround the first region 430 and extend in directions toward a first side 404 and a second side 405 of the head portion. The third region 434 may be disposed adjacent to the second region 432, also extending toward the first side 404 and the second side 405 of the head portion. One or more additional regions 436 may be positioned outside of the third region 434.

The frame 420 surrounding at least a portion of the core 410 may also or instead contribute to a property distribution system. In some implementations, the frame 420 may be structurally configured to provide a fourth property (e.g., a fourth weight) along each of the first side 404 and the second side 405 of the head portion, where the fourth weight may be greater than the first weight provided by the first region 430. In certain aspects, the fourth weight provided by the frame 420 may be greater than each of the first weight, the second weight, and the third weight provided by the respective regions of the core 410. This configuration may further enhance the paddle’s resistance to twisting during off-center hits or otherwise.

Referring back to FIG. 2, the frame 120 may include a second filler 222. The second filler 222 may provide at least a part of the fourth weight along the first side and the second side of the head portion. The use of the second filler 222 within the frame 120 may thus allow for additional customization of a weight distribution system, potentially enhancing the paddle’s performance characteristics. In an aspect, the second filler 222 may have an increased weight, or density, relative to one or more of the core regions. In an aspect, the second filler 222 may not completely fill the frame 120. In an aspect, the second filler 222 may be disposed within an outermost portion of the frame 120. In an aspect, the second filler 222 may be disposed external to the frame (e.g., between the frame 120 and the edge guard 250, or as part of the edge guard 250). One or more of these features of the second filler 222 may improve the swing weight (torsion resistance) of the paddle, by shifting the weight distribution towards the sides of the paddle. In addition, or instead, the second filler 222 may add protection to the paddle by reinforcing the frame 120.

Referring again to FIG. 4, the gradient distribution of weights and/or other properties across the paddle head, from the first region 430 outwardly to the one or more additional regions 436, may provide a smooth transition in feel for the player. This gradual change in properties may contribute to a more consistent performance when contacting a ball across different areas of the paddle surface.

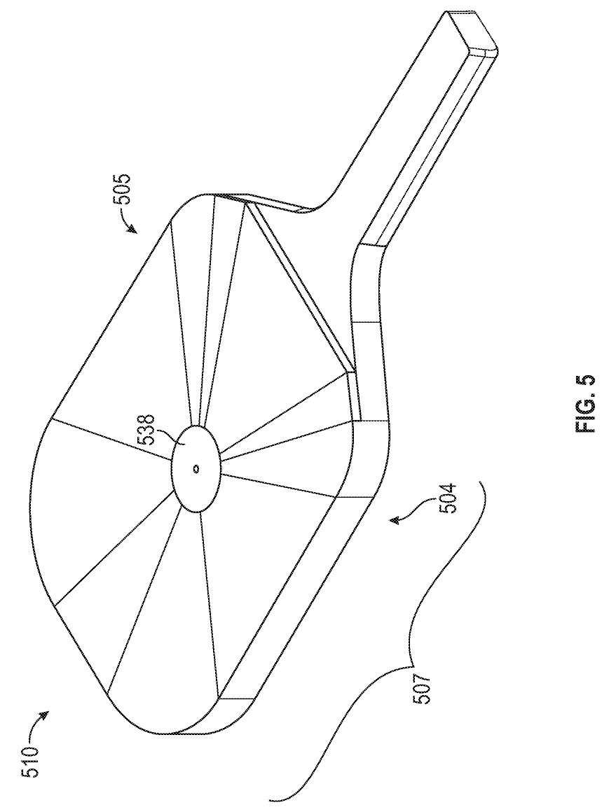

FIG. 5 shows a core 510 of a pickleball paddle, according to a representative example. This view of the core 510 may represent a stage in the manufacturing process before the core 510 is compressed to its final form. By way of example, the core 510 may be used as the core structure of the paddle described above with reference to FIG. 1. Turning back to FIG. 5, the structure of the core 510 may be designed to create a compression gradient—e.g., a gradual transition of properties—when the core 510 is compressed in a mold. For example, prior to compression, the thickness of the core may gradually increase from a center 538 to each of a first side 504 and a second side 505. The variable thickness of the core 510 may result in different compression rates across the width of the head portion 507, potentially leading to varying densities and/or properties in the final paddle construction. This customization may enhance the paddle’s resistance to twisting during off-center hits and provide a more consistent feel across the striking surface.

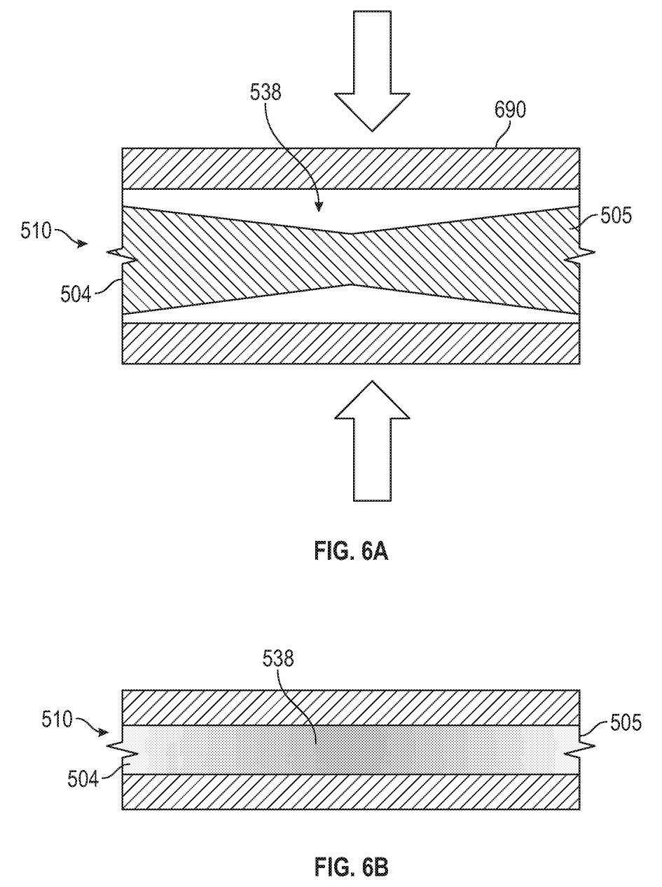

FIG. 6A shows an end view of the core 510 of FIG. 5 before pressure is applied, and FIG. 6B shows the core 510 after pressure is applied, according to a representative example. The core 510 includes a center portion, located substantially in the center 538 of the core 510, that extends laterally toward the first side 504 and the second side 505. Prior to compression, the core 510 exhibits a varying thickness profile where the thickness increases from the center 538 towards the first side 504 and the second side 505, creating a generally concave cross-sectional shape. In manufacturing, pressure may be applied to the core 510, e.g., by one or more plates 690 of a mold along the directional arrows shown.

The view of FIG. 6B shows the core 510 after compression, having a substantially constant thickness with a gradient distribution of regions having different densities as indicated by the gradient shading, e.g., the center 538 may have a lower density compared to the regions extending toward the first side 504 and the second side 505. The variable thickness configuration of the core 510 shown in FIGS. 5 & 6A may allow for different compression rates when the core 510 is subsequently pressed during the manufacturing process. This differential compression may result in varying densities and/or material properties across the width of the core 510 in the final paddle construction. For example, the regions near the first side 504 and the second side 505 may exhibit higher densities, potentially increasing the weight and stiffness in these areas. Conversely, the center 538 may maintain a lower density, potentially providing different performance characteristics in the central region of the paddle. In some cases, the resulting density gradient may enhance the paddle’s resistance to twisting during off-center hits by concentrating more weight towards the first side 504 and the second side 505 of the head portion. The gradual transition of performance properties from the center 538 towards the first side 504 and the second side 505, may potentially contribute to a more consistent feel across the paddle surface during play.

While the variable-thickness compression technique provides an effective way to establish a property distribution, it will be understood that other manufacturing techniques may also or instead be employed to achieve a similar result. For example, a property distribution system may be implemented via additive manufacturing (e.g., 3D printing), where a lattice or cellular structure is formed with a spatially varying geometry—such as a localized increase in wall thickness or a decrease in cell size—to define distinct performance regions or a continuous gradient. In another aspect, a gradient may be formed through multi-shot or regional molding, where different materials or materials with different densities are sequentially or simultaneously introduced into specific sections of the paddle head portion. Furthermore, a distribution may be achieved by localized chemical treatment or variable curing of a core material, such as by utilizing different concentrations of blowing agents in a foam core to create localized density variations. Additionally, the property distribution may be established by the strategic placement of localized fillers, adhesive layers, or reinforcements—including metallic, composite, or high-density polymer components—within the core or at the interface between the core and the playing surfaces to selectively tune the torsion resistance or feel of the paddle.

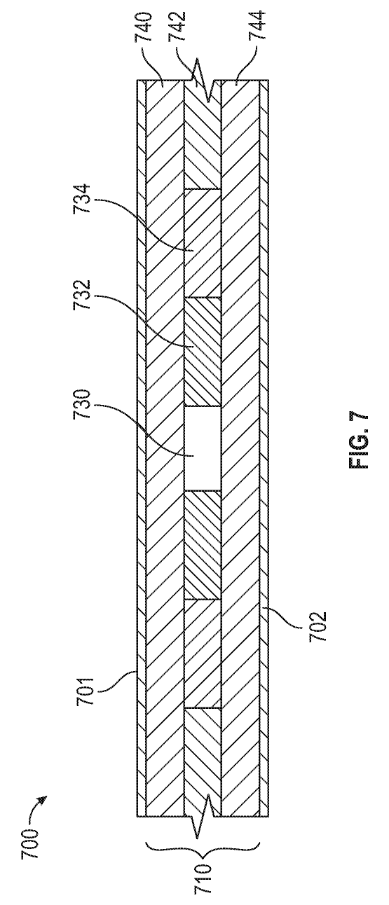

FIG. 7 shows a core of a pickleball paddle, according to a representative embodiment. The paddle 700 may include a first surface 701 and a second surface 702 arranged on opposite sides of a core 710. By way of example, the core 710 may be used as the core structure of the paddle described above with reference to FIG. 1. Turning back to FIG. 7, the core 710 may include multiple layers, e.g., including a first layer 740, a second layer 742, and a third layer 744. The core 710 may include at least three distinct regions arranged across its width: a first region 730 positioned substantially in the center, a second region 732 adjacent to the first region 730, and a third region 734 adjacent to the second region 732. These regions are shown extending through the second layer 742, but may also or instead extend through either or both the first layer 740 or the third layer 744 of the core 710.

The first layer 740, second layer 742, and third layer 744 may be arranged in a stacked configuration between the first surface 701 and the second surface 702. In certain aspects, the layers may have different material properties, densities, and/or structural characteristics that contribute to the overall performance characteristics of the paddle 700. For example, one of the first region 730, the second region 732, or the third region 734 may include fibers having a fiber areal weight of between about 100 g/m² and about 150 g/m²; another of the first region 730, the second region 732, or the third region 734 (e.g., a region located toward the sides of the paddle head) may include fibers having a fiber areal weight of at least about 150 g/m². In addition, or instead, the first surface 701 and/or the second surface 702 may each include a plurality of layers of material. In an aspect, one or more of the first surface 701 and the second surface 702 may include a different number of layers in the first region 730, the second region 732, and/or the third region 734. These surface layers may incorporate a gradient distribution achieved, for example, by varying fiber orientation, fiber layup, or resin ratios across different regions of the paddle 700. In an aspect, some layers, or regions of layers, may have a resin ratio of about 20%, while other layers, or regions of layers (e.g., regions located toward the sides of the paddle head), may have a resin ratio of between about 20% and about 40% (where the resin is heavier than the fiber).

The regions 730, 732, 734 may be arranged to provide a graduated transition of properties from the center toward the edges of the paddle 700 (e.g., as described in FIGS. 3 or 4). This arrangement allows for customization of weight distribution and/or other physical properties across the width of the paddle 700. The core 710 or the surfaces 701, 702 may be formed of multiple layers, with only some layers having the gradient distribution. For example, in the core 710, the first layer 740 may have a uniform composition, while the second layer 742 and the third layer 744 may incorporate the gradient distribution across the first region 730, second region 732, and third region 734. The layered construction of the paddle 700, combined with the gradient distribution of properties across the regions 730, 732, 734, may contribute to enhanced performance characteristics.

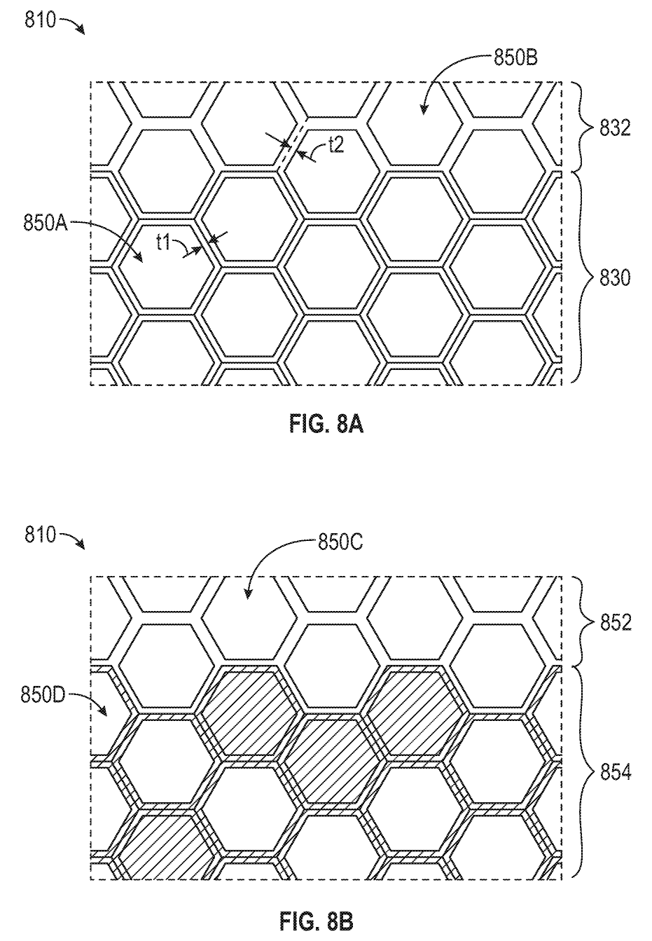

FIGS. 8A and 8B show enlarged partial views of a core 810 of a pickleball paddle, according to a representative example. The core 810 may include a plurality of cells, where cells 850A may form a first region 830 of the core 810 and cells 850B may form a second region 832 of the core 810. In an aspect, the cells 850A may include a different material than the cells 850B. In another aspect, the cells 850A may include the same material as the cells 850B, but may have a different material property. For example, as shown in FIG. 8A, the cells 850A may have a wall thickness, t1, that is different from a wall thickness, t2, of the cells 850B. In this manner, the cells having a greater wall thickness may form a region having an increased weight relative to cells with the lesser wall thickness (for example, if wall thickness t1 is less than wall thickness t2, the cells 850A of the first region 830 would have less weight than the cells 850B of the second region 832). In an aspect, the wall thickness, t1, of cells 850A may be about 0.12 mm, and the wall thickness, t2, of cells 850B may be between about 0.2 mm and about 1 mm. In another aspect, the wall thickness, t1, of cells 850A may be between about 0.08 mm and about 0.15 mm, and the wall thickness, t2, of cells 850B may be between about 0.15 mm and about 2 mm.

In an aspect, the different wall thicknesses (e.g., t1 and t2) of the cells 850A, 850B may be formed from the same material through integral thickening during manufacturing. For example, such thickening may be achieved via controlled extrusion profiles, varying deposition rates or layer heights in an additive manufacturing process, or through localized compression or expansion within a mold to vary the density of the cell wall material in specific regions. Variations in wall thickness may also or instead include the partial filling of the cells 850A, 850B specifically along the interior or exterior surfaces of the cell walls, thereby increasing the effective wall thickness and localized weight of a specific region without completely obstructing or closing the cell structure. In this manner, the core 810 may be selectively reinforced to provide a graduated performance property distribution while maintaining the desired structural integrity of the overall paddle.

In another aspect, as shown in FIG. 8B, a first region 852 may include a substantially open cell structure having open cells 850C, while a second region 854 may include a substantially closed cell structure having closed cells 850D (e.g., some or all of the cells 850D may be solid or at least partially filled with a filler which may be the same material or a different material than the cell walls). Also or instead, the transition between the first region 852 and the second region 854 may be characterized by a gradual change in the volume, density, or distribution of a filler material within the cells 850C, 850D. For example, the cells may be partially filled in a manner that increases the effective density of the core 810 without completely closing the cell structure, such as by disposing a filler material only along the interior cell walls or occupying a predetermined percentage (e.g., 25%, 50%, or 75%) of the internal cell volume. In this implementation, the filler may transition from a low-volume or zero-filling state in the center of the head portion to a high-volume or complete-filling state toward the outer perimeter, or vice-versa. Such a transition may be continuous or may cross a functional threshold where the cells effectively behave as closed cells, thereby providing a localized increase in weight, stiffness, vibration damping, or to enhance the paddle’s resistance to twisting during off-center impacts.

It will be understood that the terms “first region” and “second region” in the foregoing examples are generic terms that may refer to any of a first region, a second region, a third region, or an additional region as described herein. In other example aspects, the first region 852 and/or the second region 854 region may include a difference in one or more of cell shape, cell size, cell material, and cell wall thickness relative to another region. In an example aspect, the major dimension of cells of one of the first region, the second region, or the third region may be about 8 mm, and the major dimension of cells of another of the first region, the second region, or the third region may be between about 4 mm and about 14 mm. These structural differences in the core regions may contribute to the regions having differences in one or more of stiffness, hardness, vibration damping characteristics, and the like.

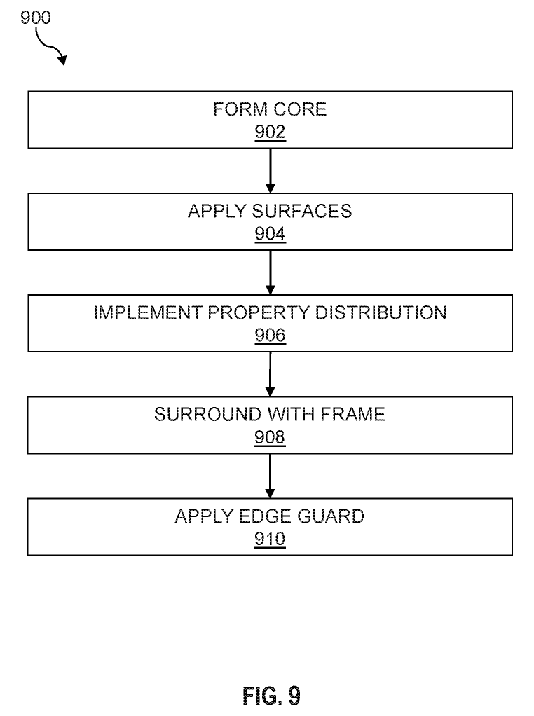

FIG. 9 is a flow chart of a method 900 of manufacturing a pickleball paddle, in accordance with a representative example. The method 900 may be used to create a paddle with a customized distribution of weight and/or performance characteristics as described herein, e.g., the paddle 100 of FIG. 1 or any other as described herein.

As shown in step 902, the method 900 may include forming a core. The core may be similar to any of the cores described herein (e.g., the core 310), and may be formed with a plurality of regions having differing weights to provide at least a part of a weight distribution system (e.g., a first region 330, a second region 332, a third region 334, and/or one or more additional regions 336). In an aspect, step 902 may include forming a first region of a core, where the first region may include a first material structurally configured to provide a first weight of the first region; forming a second region of the core, where the second region may include a second material structurally configured to provide a second weight of the second region, the second weight being greater than the first weight; and forming a third region of the core, where the third region may include a third material structurally configured to provide a third weight of the third region, the third weight being greater than the second weight. In an aspect, forming the core may include locating the first region substantially in a center of a head portion, disposing the second region adjacent to the first region at least along sides of the first region in a direction toward each of the first side and the second side of the head portion, and disposing the third region adjacent to the second region at least along sides of the second region in the direction toward each of the first side and the second side of the head portion. In certain aspects, the core may also or instead have varying properties, such as different densities or structural configurations across its width, where these varying properties provide advantageous playing characteristics for the paddle.

As shown in step 904, the method 900 may include applying a front surface and a back surface to the core. The front surface and the back surface may be similar to the first surface 101 and the second surface 202 described in FIGS. 1 & 2, or other surfaces described herein. In certain aspects, one or more of the front surface and the back surface may have varying properties, including a plurality of sections of surface material, each section having different properties such as density, stiffness, hardness, and/or vibration damping characteristics, and/or a plurality of layers.

As shown in step 906, the method 900 may include implementing a property distribution system. In an aspect, the property distribution system may include a weight distribution system implemented by forming the core as described in step 902 and also, or instead, by other features as described herein to distribute weight across the paddle head. The property distribution system may be structurally configured to provide a variable performance property (e.g., an increasing weight distribution) from a center region of the pickleball paddle towards an outer perimeter of the pickleball paddle. This step may involve manipulating the properties of the core (e.g., applying compression as described in FIGS. 6A & 6B), the front surface, and/or the back surface to achieve the desired property distribution.

As shown in step 908, the method 900 may include surrounding the core with a frame. The frame may be similar to the frame 120 described earlier and may (or may not) contribute to the property distribution system (e.g., via the second filler 222). In certain aspects, the frame may be structurally configured to provide a predetermined weight along each of the first side and the second side of the head portion that is greater than the weight in the center region of the paddle.

As shown in step 910, the method 900 may include applying an edge guard. The edge guard may be similar to the edge guard 250 described in FIG. 2 and may (or may not) contribute to the property distribution system. In certain aspects, the edge guard may provide additional weight along the perimeter of the paddle, further enhancing the paddle’s resistance to twisting during off-center hits.

The method 900 for manufacturing a pickleball paddle allows for the creation of a paddle with a customized weight distribution and/or performance characteristics. By carefully controlling the properties of the core, surfaces, frame, edge guard, and the like, the resulting paddle may offer improved stability and a more consistent feel across the striking surface, or may provide other advantages during gameplay.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A pickleball paddle, the paddle comprising:
a handle portion;
a head portion including a first side, a second side, a top portion, and a throat portion; and
a core defining at least a majority of an interior of the head portion, the core comprising:
a first region located substantially in a center of the head portion, the first region including a first material structurally configured to provide a first weight of the first region;
a second region disposed adjacent to the first region at least along sides of the first region in a direction toward each of the first side and the second side of the head portion, the second region including a second material structurally configured to provide a second weight of the second region, the second weight greater than the first weight; and
a third region disposed adjacent to the second region at least along sides of the second region in the direction toward each of the first side and the second side of the head portion, the third region including a third material structurally configured to provide a third weight of the third region, the third weight greater than the second weight,
wherein weight distribution provided by the first region, the second region, and the third region increases resistance of the paddle to twisting when contacting a ball along one or both of the first side and the second side of the head portion relative to paddles lacking the weight distribution.

2. The paddle of claim 1, wherein the first material, the second material, and the third material have different material properties.

3. The paddle of claim 1, wherein one or more of the first region, the second region, and the third region include a gradient of a material property across at least a portion thereof.

4. The paddle of claim 1, wherein one or more of density, size, material distribution, shape, and physical structure provide different weights for at least two regions using the same materials.

5. The paddle of claim 1, wherein at least two of the first region, the second region, and the third region have differences in one or more of the following: stiffness, hardness, and vibration damping.

6. The paddle of claim 1, wherein the first region includes a first substantially open cell structure.

7. The paddle of claim 6, wherein one or more of the second region and the third region include a substantially open cell structure.

8. The paddle of claim 7, wherein the first substantially open cell structure of the first region is different than the substantially open cell structure of one or more of the second region and the third region.

9. The paddle of claim 8, wherein the first substantially open cell structure includes a difference in one or more of the following relative to the substantially open cell structure of one or more of the second region and the third region: cell shape, cell size, and cell wall thickness.

10. The paddle of claim 1, wherein the second region completely surrounds the first region.

11. The paddle of claim 10, wherein the second weight is greater along sides of the second region than it is toward one or both of the top portion and the throat portion.

12. The paddle of claim 1, wherein the third region completely surrounds the second region.

13. The paddle of claim 12, wherein the third weight is greater along sides of the third region than it is toward one or both of the top portion and the throat portion.

14. The paddle of claim 1, wherein the first region contacts the second region and the second region contacts the third region.

15. The paddle of claim 1, further comprising a frame structurally configured to provide a fourth weight along each of the first side and the second side of the head portion, the fourth weight greater than the first weight.

16. A pickleball paddle, the paddle comprising:
a handle portion; and
a head portion including a first side, a second side, a top portion, and a throat portion, the head portion comprising:
a first region located substantially in a center of the head portion, the first region including a first material structurally configured to provide a first weight of the first region;
a second region disposed adjacent to the first region at least along sides of the first region in a direction toward each of the first side and the second side of the head portion, the second region including a second material structurally configured to provide a second weight of the second region, the second weight greater than the first weight; and
a third region disposed adjacent to the second region at least along sides of the second region in the direction toward each of the first side and the second side of the head portion, the third region including a third material structurally configured to provide a third weight of the third region, the third weight greater than the second weight,
wherein weight distribution provided by the first region, the second region, and the third region increases resistance of the paddle to twisting when contacting a ball along one or both of the first side and the second side of the head portion relative to paddles lacking the weight distribution.

17. The paddle of claim 16, wherein the first region, the second region, and the third region are formed in one or more of a front surface and a back surface of the paddle.

18. A method of manufacturing a pickleball paddle, the method comprising:
forming a first region of a core, the first region including a first material structurally configured to provide a first weight of the first region;
forming a second region of the core, the second region including a second material structurally configured to provide a second weight of the second region, the second weight greater than the first weight;
forming a third region of the core, the third region including a third material structurally configured to provide a third weight of the third region, the third weight greater than the second weight;
forming the core with the first region located substantially in a center of a head portion, the second region disposed adjacent to the first region at least along sides of the first region in a direction toward each of the first side and the second side of the head portion, and the third region disposed adjacent to the second region at least along sides of the second region in the direction toward each of the first side and the second side of the head portion;
applying a front surface and a back surface to the core, the front surface opposing the back surface; and
implementing a weight distribution system structurally configured to provide an increasing weight distribution from a center region of the pickleball paddle towards an outer perimeter of the pickleball paddle, wherein weight varying properties of the core comprise at least a part of the weight distribution system.

19. The method of claim 18, wherein one or more of the front surface and the back surface include a plurality of regions having differing weights to provide at least a part of the weight distribution system.

20. The method of claim 18, further comprising surrounding the core with a frame that contributes to the weight distribution system.
